(19) United States
(12) Patent Application Publication
(10) Pub. No.: US 2026/0017504 A1
(43) Pub. Date: Jan. 15, 2026

(54) PROGRAMMABLE IN-MEMORY ACCELERATOR ARCHITECTURE FOR TRANSFORMER MODELS

(71) Applicant: Hewlett Packard Enterprise Development LP, Spring, TX (US)

(72) Inventors: Lei Zhao, Fort Collins, CO (US); Luca Buonanno, Fort Collins, CO (US); Giacomo Pedretti, San Francisco, CA (US)

(21) Appl. No.: 18/772,940

(22) Filed: Jul. 15, 2024

(51) Int. Cl. G06N 3/063; G06N 3/0455

(52) U.S. Cl. CPC G06N 3/063; G06N 3/0455

(57) ABSTRACT

In certain examples, a method includes obtaining, by a dot product device, an input vector; performing, by the dot product device, a first matrix-vector multiplication operation to obtain a query matrix; performing, by the dot product device, a second matrix-vector multiplication operation to obtain a key matrix; performing, by the dot product device, a third matrix-vector multiplication operation to obtain a value matrix; performing, by a general computing analog content addressable memory (GC-ACAM) device, a first matrix multiplication using the query matrix and the key matrix to obtain a query key result; performing, by the GC-ACAM device, a scaling operation to obtain a scaled query key result; executing, by the GC-ACAM device, a softmax function using the scaled query key result to obtain a softmax result; and performing, by the GC-ACAM device, a second matrix multiplication using the value matrix and the softmax result to obtain an attention result.

### BACKGROUND

Neural networks are a class of machine learning algorithms inspired by the structure and function of the human brain. They consist of interconnected nodes, organized into layers, where each node takes input data, processes it, and passes the output to the next layer. These networks are trained on large amounts of data, by adjusting the connection strengths (e.g., weights) between nodes. As a result, neural networks can learn complex patterns and representations from the data, enabling them to excel in tasks like natural language processing, image recognition, and decision-making. A significant advancement in neural networks is the transformer model architecture.

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 is a block diagram of a computing system, in accordance with to one or more examples disclosed herein.

FIG. 2 is a block diagram of an attention accelerator, in accordance with to one or more examples disclosed herein.

FIG. 3 shows an example programmable crossbar array of an attention accelerator, in accordance with to one or more examples disclosed herein.

FIG. 4 shows an example GC-ACAM device portion of an attention accelerator, in accordance with to one or more examples disclosed herein.

FIG. 5 shows an example of an ACAM cell of an attention accelerator, in accordance with to one or more examples disclosed herein.

FIG. 6 illustrates an overview of an example method for executing an attention mechanism of a transformer, in accordance with to one or more examples disclosed herein.

The figures are drawn to illustrate various aspects of the disclosure and are not necessarily drawn to scale.

### DESCRIPTION

The following disclosure provides many different examples for implementing different features. Specific examples of components and arrangements are described below to simplify the present disclosure. These are, of course, merely examples and are not intended to be limiting.

Machine learning models may be used to perform a variety of tasks. Machine learning models may be provided training data, from which the machine learning model may learn to predict or otherwise generate results. A trained machine learning model may be provided input data and, based on previously performed learning, generate an output. One type of machine learning model is a neural network. A neural network may receive an input sequence and generates an output sequence. Some types of neural networks, such as, for example, generative pre-trained transformers (GPTs), use a transformer model architecture. Transformer models (which may be referred to herein as transformers) may be used in a variety of machine learning scenarios, including, but not limited to, natural language processing, image processing, audio processing, multi-modal processing, robotics, language translation, generative artificial intelligence, and the like. As an example, GPTs may be used as large language models (LLMs), which may be pre-trained on large data sets to become capable of generating content, such as text, images, and the like.

The transformer model uses an attention mechanism. An attention mechanism may calculate the relationships of the elements of the input sequence to one another. In one or more examples, the relationships between the elements of the input sequence are used, at least in part, to generate the output sequence. Such relationships may be characterized by an output of an attention mechanism, which may be referred to as an attention matrix. In some examples, an attention matrix may be calculated using the following equation:

$$A = SoftMax ( \frac{Q {K}^{T}}{\sqrt{{d}_{k}}} ) V$$

In the above equation, Q is a query matrix, which may be obtained by multiplying an input vector X (e.g., corresponding to a tokenized representation of an input to the transformer) by a query weight matrix W^{Q}. K is a key matrix, which may be obtained by multiplying the input vector X by a key weight matrix W^{K}. V is a value matrix, which may be obtained by multiplying the input vector X by a value weight matrix W^{V}. The weight matrices may be determined, for example, during training of a transformer model. The value dk is a scaling factor, which may correspond, for example, to a dimension of keys (e.g., vectors in the K matrix), queries (e.g., vectors in the Q matrix), and/or an input vector. A is the attention matrix. Thus, according to the above equation, A may be calculated by multiplying the query matrix Q by the transpose of the key matrix K (e.g., K^{T}), scaling the result by dividing by the square-root of dk, executing the softmax function for the scaled result, and multiplying the softmax result by the value matrix V. The softmax function normalizes a set of values into a probability distribution, and may, in some examples, be calculated using the following equation:

$$softmax ( Xi ) = SoftMax ( \frac{{e}^{Xi}}{{\sum }_{j = 1}^{L} {e}^{Xj}} ) V$$

Executing an attention mechanism for a transformer is often a latency bottleneck for execution times of the transformer. Additionally, executing the operations required for the attention mechanism may be expensive in terms of size and power efficiency when implemented using conventional techniques, such as, for example, digital CMOS-based techniques and components, conventional processors, conventional memory architectures, and the like. Also, acceleration techniques for improving execution of the attention mechanism may be challenging, as some operations (e.g., the softmax function, including the division therein) may be challenging to implement using accelerators such as resistive random access memory (ReRAM) or memristor-based crossbar arrays. Such crossbar arrays also present a challenge for implementing portions of the attention mechanism, as the Q, K, and V matrices change with each input X (which is multiplied by the respective weight matrices), and would thus require frequent reprogramming of the crossbar arrays.

To address, at least in part, the aforementioned challenges, examples disclosed herein provide in-memory techniques that use crossbar arrays and general computing analog content addressable memory (GC-ACAM) devices, along with other circuitry components, to accelerate the execution of the attention mechanism of a transformer. Examples disclosed herein include dot product devices that include programmable crossbar arrays for computing the results of matrix-vector multiplications of inputs (e.g., a vector X) and weight matrices (e.g., W^{Q}, W^{K}, and W^{V}) to obtain Q, K, and V matrices.

Once the Q, K, and V matrices are obtained, a number of GC-ACAMs, adders, and other circuitry components may be configured to perform the various operations of the equations above for computing an attention matrix for an input, including matrix multiplication, addition, subtraction, scaling (e.g., multiplication by a scalar value), and the softmax function.

In one or more examples, the softmax function is converted into a form that avoids the use of a division operation, so that the softmax function may be executed using the aforementioned components (e.g., GC-ACAMs and adders), such as matrix multiplications, exponential functions, and logarithmic functions. In one or more examples, performing the various operations of the attention mechanism of a transformer using in-memory hardware devices such as crossbar arrays, GC-ACAMs, adders, and the like improves throughput of the attention mechanism, thereby increasing speed of transformer execution, while avoiding, at least in part, the need to use expensive digital circuitry.

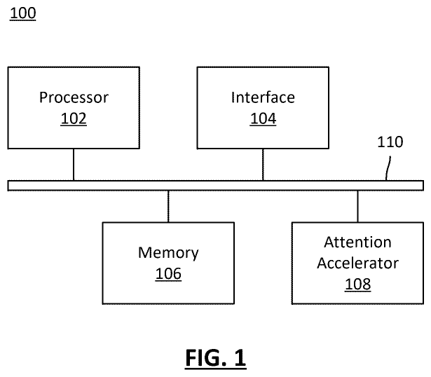

FIG. 1 is a block diagram of a computing system 100, which may be used to operate a transformer model (e.g., as part of a machine learning model, such as a neural network), according to some implementations. The computing system 100 may be implemented in an electronic device. Examples of computing systems may include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, any other type of storage device), a network device (e.g., switch, router, multi-layer switch, any other type of network device), a virtual machine, a virtualized computing environment, a logical container (e.g., for one or more applications), a container pod, an Internet of Things (IoT) device, an array of nodes of computing resources, a supercomputing device, a data center or any portion thereof, and/or any other type of computing device. As one of ordinary skill in the art will appreciate, any of the aforementioned examples of computing devices necessarily require at least some hardware components. As an example, a virtual machine, a container, and/or a container pod, when considered as a computing device, include the underlying hardware on which the virtual machine, a container, and/or a container pod executes.

The computing system 100 may be utilized in any data processing scenario, including stand-alone hardware, application execution (e.g., mobile applications, server applications, and the like), or combinations thereof. Further, the computing system 100 may be used in any computing network, such as, for example, a public cloud network, a private cloud network, a hybrid cloud network, other forms of networks, or combinations thereof. In one example, the methods provided by the computing system 100 are provided as a service over a network by, for example, a third party, and/or may be executed on computing systems separate from other computing systems or networks. The computing system 100 may be implemented on one or more hardware platforms, in which modules in the system may be executed on one or more platforms. Such modules may run on various forms of cloud technologies and hybrid cloud technologies or be offered as a Software-as-a-Service that may be implemented on or off a cloud network.

To achieve its desired functionality, the computing system 100 includes various hardware components. These hardware components may include a processor 102, an interface 104, a memory 106, and an attention accelerator 108. The hardware components may be interconnected through a number of busses and/or network connections. In one example, the processor 102, the interface 104, the memory 106, and the attention accelerator 108 may be communicatively coupled via a bus 110, such as a PCI-Express bus. Other components for facilitating communication between components of the computing system 100 may be used without departing from the scope of examples disclosed herein.

In one or more examples, the processor 102 retrieves executable code from the memory 106 and executes the executable code. The executable code may, when executed by the processor 102, cause the processor 102 to implement all or any portion of the functionality described herein. In one or more examples, the processor 102 may be an integrated circuit for processing instructions. For example, the processor 102 may be one or more cores or micro-cores of a processor. The processor 102 may be a general-purpose processor configured to execute program code included in software executing on the computing system 100. The processor 102 may be a special purpose processor where certain instructions are incorporated into the processor design. The processor 102 may be an application specific integrated circuit (ASIC), a graphics processing unit (GPU), a data processing unit (DPU), a tensor processing units (TPU), an associative processing unit (APU), a vision processing units (VPU), a quantum processing units (QPU), and/or various other processing units that use special purpose hardware (e.g., field programmable gate arrays (FPGAs), System-on-a-Chips (SOCs), digital signal processors (DSPs)). Although only one processor 102 is shown in FIG. 1, the computing system 100 may include any number of processors without departing from the scope of examples disclosed herein.

The interface 104 enables the processor 102 to interact with various other hardware components, external to and/or internal to the computing system 100. For example, the interface 104 may include interface(s) to input/output devices, such as, for example, a display device, a mouse, a keyboard, etc. Additionally, or alternatively, the interface 104 may include interface(s) to storage devices, network devices, host devices, or the like of the computing system 100.

The memory 106 may include various types of memory, including volatile and nonvolatile memory. For example, the memory 106 may include Random-Access Memory (RAM), Read-Only Memory (ROM), a Hard Disk Drive (HDD), persistent memory (Pmem) devices, and/or the like. Different types of memory may be used for different data storage needs. For example, the processor 102 may boot from ROM, maintain nonvolatile storage in an HDD, execute program code stored in RAM, and store data under processing in RAM. The memory 106 may include one or more non-transitory computer readable mediums that store(s) instructions for execution by the processor 102. As used herein, the term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, and/or any other memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. However, when mentioned, non-transitory computer-readable storage media expressly exclude media such as energy, carrier signals, electromagnetic waves, and signals per se.

One or more modules within the computing system 100 may be partially or wholly embodied as software and/or hardware for performing any functionality described herein. For the avoidance of doubt, any software executed by the computing system 100 necessarily executes using at least some portion of the hardware components of the computing system 100

The attention accelerator 108, may, for example, be used by the processor 102 to accelerate processing of a machine learning model, and, more specifically, to accelerate execution of an attention mechanism of a transformer. The attention accelerator 108 is different than the processor 102. The attention accelerator may include dot product devices for performing matrix-vector multiplication operations, and any number of GC-ACAMs, adders, and other circuitry components for performing a variety of operations, including, but not limited to, matrix multiplications, exponential function calculations, logarithmic function calculations, additions, subtractions, and the like. The GC-ACAMs of the attention accelerator 108 may be configured to perform any of a variety of predetermined functions having one or more input variables, and may interact with other circuitry to produce outputs that are used in executing the attention mechanism of a transformer. The attention accelerator 108 may be able to process the attention mechanism of a transformer more efficiently than a general-purpose central processing unit (e.g., the processor 102). Accordingly, the attention accelerator 108 may improve the performance of the computing system 100.

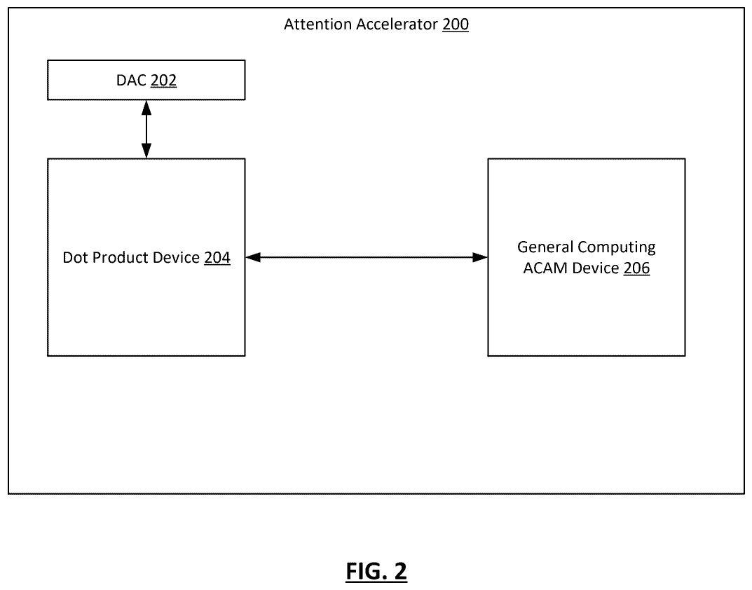

FIG. 2 is a block diagram of an attention accelerator 200 in accordance with one or more examples disclosed herein. The attention accelerator 200 may be the same as or similar to the attention accelerator 108 shown in FIG. 1 and discussed above. As shown in FIG. 2, the attention accelerator 200 includes a digital to analog converter (DAC) 202, a dot product device 204, and a GC-ACAM device 206. Each of these components is described below.

In one or more examples, the attention accelerator 200 is used to execute the attention mechanism equation set forth above. To that end, the attention accelerator 200 may be configured to perform matrix vector multiplications, matrix multiplications, additions, subtractions, scaling functions (e.g., multiplication by a scalar value, shift operations) exponential functions, logarithmic functions, and the like.

In one or more examples, the attention accelerator 200 includes the DAC 202. In one or more examples, the DAC 202 is a component for converting digital signals to analog signals. In one or more examples, the digital-to-analog converter 202 receives a digital input X (e.g., a vector or matrix from the processor 102 shown in FIG. 1), and converts the digital input X to an analog input X. Each row of a digital input matrix X may be an element of an input sequence for a transformer (e.g., a vector). Each element of an analog input matrix X may be an analog signal that corresponds to an element of the digital input matrix X for the transformer. Specifically, in one or more examples, the voltage of an element of the analog input matrix X may be proportional to the digital value of the corresponding element of the digital input matrix X. Example digital-to-analog converters include, but are not limited to, resistor strings, delta-sigma modulators, and the like. The digital-to-analog converter 202 may include a plurality of converter modules (e.g., one for each row of the digital input matrix X), or one converter module with multiple channels.

In one or more examples, the DAC 202 is operatively connected to the dot product device 204. In one or more examples, the dot product device 204 includes any number of programmable crossbar arrays for executing matrix-vector multiplications. In one or more examples, each programmable crossbar array may be programmed with a weight matrix. As an example, the dot product device 204 may include a first programmable crossbar array programmed with the query weight matrix W^{Q}, a second programmable crossbar array programmed with the key weight matrix W^{K}, and a third programmable crossbar array programmed with the value weight matrix W^{V}. In such an example, an input vector X, which is an analog representation of at least a portion of an input to a transformer, may be input the each of the three programmable crossbar arrays to be multiplied, respectively, by each of the three weight matrices to obtain the query matrix Q, the key matrix K, and the value matrix V. At least some of the matrix vector multiplications may be performed in parallel (e.g., to obtain Q and K), or may be performed at separate times as needed (e.g., the matrix vector multiplication to obtain V prior to multiplying V with the result of the softmax function of the attention equation).

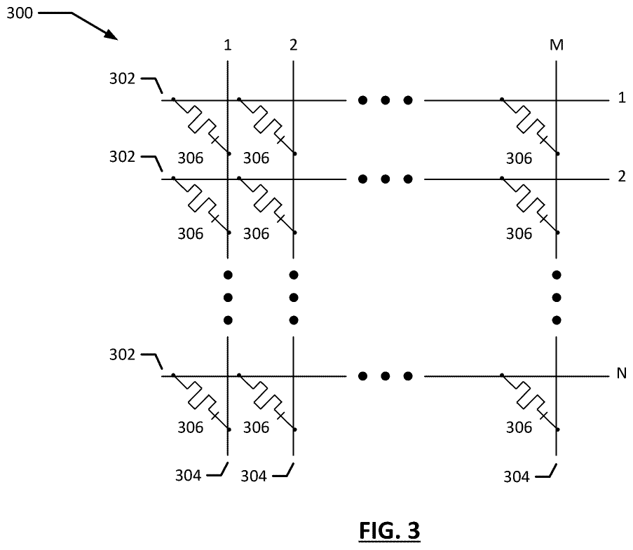

FIG. 3 shows an example programmable crossbar array 300 in accordance with one or more examples herein. Any number of such programmable crossbar arrays may be included in the dot product device 204 of FIG. 2. As an example, the dot product device 204 may include programmable crossbar arrays for generating the Q, K, and V matrices used for executing an attention mechanism of a transformer, for a total of at least three programmable crossbar arrays. The dot product device 204 may include a different number of programmable crossbar arrays without departing from the scope of examples disclosed herein. The description below of FIG. 3, and the programmable crossbar array shown therein, are a generalized description of how the programmable crossbar array may be used to perform matrix-vector multiplications, such as, for example, the generation of the Q, K, and V matrices.

In one or more examples, the programmable crossbar array 300 includes a plurality of input electrodes 302, a plurality of output electrodes 304 and plurality of programmable elements 306. The input electrodes 302 are arranged in rows, the output electrodes 304 are arranged in columns. Each programmable element 306 is positioned at a crosspoint or junction of an input electrode 302 and an output electrode 304. As input, the programmable crossbar array 300 takes a vector of analog signals (on the input electrodes 302).

The programmable elements 306 are circuit elements whose conductance or resistance is programmable. The programmable elements 306 are non-volatile analog devices, which may be adapted to store one or more bits of data. An example of a programmable element is a memristor, which includes a dielectric layer (e.g., an oxide layer) between two metal layers. When the programmable elements 306 are memristors, the programmable crossbar array 300 is a memristor array. Other examples of programmable elements include multi-bit flash memory cells, resistive random-access memory (ReRAM) cells, phase-change random-access memory (PCRAM) cells, magnetoresistive random-access memory (MRAM) cells, electrochemical random-access memory (ECRAM) cells, and the like.

The programmable crossbar array 300 may also include other peripheral circuitry (not separately illustrated) associated with the programmable crossbar array 300 when used as a storage device. For example, the programmable crossbar array 300 may include drivers connected to the input electrodes 302. An address decoder can be used to select an input electrode 302 and activate a driver corresponding to the selected input electrode 302. The driver for a selected input electrode 302 can drive a corresponding input electrode 302 with different voltages corresponding to a vector-matrix multiplication or the process of setting values (e.g., conductance values, resistance values, and the like) within the programmable elements 306 of the programmable crossbar array 300. Similar driver and decoder circuitry may be included for the output electrodes 304. Control circuitry may also be used to control application of voltages at the inputs of the programmable crossbar array 300. Input signals to the input electrodes 302 and the output electrodes 304 are analog signals. The peripheral circuitry above described can be fabricated using semiconductor processing techniques in the same integrated structure or semiconductor die as the programmable crossbar array 300.

As discussed above, the programmable crossbar array 300 may be configured to perform a dot product operation to perform matrix-vector multiplication to obtain an output, such as the Q, K, and V matrices. As such, in some examples, the dot product device 204 may include separate instances of a programmable crossbar array 300 for computing each of the three aforementioned matrices. In some examples, the dot product device 204 is configured such that the input lines for each programmable crossbar array 300 are connected, so that an input vector X input on the input electrodes 302 is provided to each of the three programmable crossbar arrays. Although the above contemplates three separate crossbar arrays 300 in the dot product device 204, one of ordinary skill in the art, having the benefit of this Detailed Description, will appreciate that the dot product device 204 may include more or less crossbar arrays without departing from the scope of examples disclosed herein.

The programmable crossbar array 300 includes N input electrodes 302 and M output electrodes 304. As described in further detail below, there are two main operations that occur during operation of the programmable crossbar array 300. The first operation is to program the programmable elements 306 in the programmable crossbar array 300 so as to map the values in an N×M matrix to the programmable elements 306. As an example, the three weight matrices discussed above (e.g., W^{Q} W^{K}, and W^{V}) may each be programmed into one or more separate programmable crossbar array(s) 300 of the dot product device 204.

The second operation is the dot product or matrix-vector multiplication operation. In this operation, input voltages (e.g., the analog values of a vector representing at least a portion of an input to a transformer) are applied to the input electrodes 302 and output currents are obtained from the output electrodes 304, corresponding to the result of multiplying an N×1 vector with the N×M matrices. The input voltages may below the threshold of the programming voltage of the programmable elements 306 so the values of the programmable elements in the programmable crossbar array 300 are not changed during the vector-matrix multiplication operation.

A matrix-vector multiplication may be executed through the programmable crossbar array 300 by applying a set of voltages simultaneously along the input electrodes 302 of the programmable crossbar array 300 and collecting the currents through the output electrodes 304. The signal generated on an output electrode 304 is weighted by the corresponding values of the programmable elements 306 at the crosspoints of the output electrode 304 with the input electrodes 302, and that weighted summation is reflected in the current at the output electrode 304. Thus, the relationship between the voltages at the input electrodes 302 and the currents at the output electrodes 304 is represented by a matrix-vector multiplication of the input vector with the N×M matrix stored as the values of the programmable elements 306.

The programmable crossbar array 300 may be programmed to store the N×M query, key, and value weight matrices by modifying the values (e.g., conductance values, resistance values) of the programmable elements 306. The values of the programmable elements 306 are values corresponding to the N×M matrices. The values of the programmable elements 306 may be modified by imposing a voltage across the programmable elements 306 using the input electrode 302, the output electrodes 304, and corresponding voltage drivers. The voltage difference imposed across a programmable element 306 generally determines the resulting value of that programmable element 306. In some examples, the programming process is performed row-by-row.

Turning back to FIG. 2, the dot product device may calculate the Q, K, and V matrices, as discussed above, and provide all or any portion of the matrices, as needed to the GC-ACAM device 206. In one or more examples, the GC-ACAM device 206 is a component that is configured to perform operations of the attention accelerator 200 that are not performed by the dot product device 204. As such, the GC-ACAM device 206 may be configured to receive the Q, K, and V matrices from the dot product device, to perform matrix multiplications (e.g., Q multiplied by the transpose of K, V multiplied by the result of executing the softmax function), and to perform exponential and logarithmic functions in order to calculate the softmax function.

In one or more examples, to execute the softmax function, the GC-ACAM device is configured to first perform a matrix multiplication of Q and the transpose of K. To that end, any number of GC-ACAM arrays of the GC-ACAM device 206 may be configured to perform multiplication operations. The GC-ACAM device 206 may also be configured to perform addition operations, either using circuitry components implementing adders, or other GC-ACAM arrays for implementing addition operations. In one or more examples, the ability to perform multiplications and additions allows the GC-ACAM device to perform matrix multiplication operations, which require both multiplication of matrix elements, and addition of multiplication results.

In one or more examples, the result of multiplying Q and the transpose of K is then subjected to a scaling operation. In one or more examples, the scaling operation is performed using components of the GC-ACAM device 206. In one or more examples, the scaling operation includes multiplying the result of the matrix multiplication of Q and the transpose of K with one divided by the square root of the scaling factor dk. In some scenarios, the result of taking the square root of dk is a power of two, and thus the scaling operation may include performing right shifts or left shifts of the matrix multiplication result to obtain a scaled result. In other scenarios, when the square root of the scaling factor is not a power of two, additional ACAM arrays of the GC-ACAM device 206 may be configured to perform a scalar multiplication of the result of the matrix multiplication of Q and the transpose of K with a scalar value of one divided by the square root of the scaling factor.

In one or more examples, the GC-ACAM device 206 is configured to execute the softmax function on the scaled result obtained by performing the above-described scaling operation on the matrix multiplication result of Q and the transpose of K. However, the softmax function includes a division operation, which may be difficult to implement using ACAM arrays. Accordingly, in one or more examples, a series of mathematical operations may be performed on the softmax function to obtain the function in a form that does not include division operations. Specifically, as set forth above, the softmax function may be shown as:

$$softmax ( Xi ) = SoftMax ( \frac{{e}^{Xi}}{{\sum }_{j = 1}^{L} {e}^{Xj}} )$$

By taking the log of each side of the above equation, realizing the fact that the log of an exponential results in a value to which e is raised, and then reapplying the exponential function to both sides of the equation, the softmax function may be rewritten as:

$$softmax ( Xi ) = exp ( {e}^{Xi} - log ( {\sum }_{j = 1}^{L} {e}^{Xj} ) )$$

As can be seen in the above equation, as rewritten, the softmax function no longer includes a division operation. As such, in one or more examples, the softmax function may now be executed by the GC-ACAM device 206 using ACAM arrays configured to execute pre-determined functions such as exponential and logarithmic functions, and adders to compute summations.

In one or more examples, once the softmax result is computed, as discussed above, the result may be multiplied, via matrix multiplication, with the V matrix to obtain the attention matrix A. The V matrix may be provided, as discussed above, by the dot product device 204, and the matrix multiplication may be performed, as discussed above, using ACAM arrays and adders of the GC-ACAM device 206.

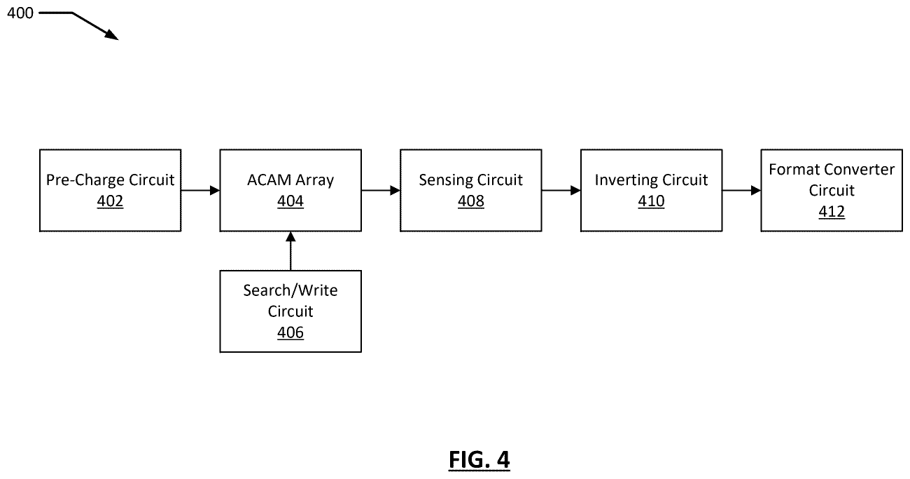

An example of at least a portion of one configuration of a GC-ACAM device is shown in FIG. 4 as GC-ACAM device portion 400. The GC-ACAM device portion 400 may be part of the GC-ACAM device 206 shown in FIG. 2 and discussed above. As shown in FIG. 4, the GC-ACAM device portion 400 includes a pre-charge circuit 402, an ACAM array 404, a search/write circuit 406, a sensing circuit 408, an inverting circuit 410, and a format converter circuit 412. Each of these components is described below.

In one or more examples, the GC-ACAM device 206 includes any number of GC-ACAM device portions 400 for performing any number of predetermined functions in order to execute the various operations of the attention mechanism being executed by the attention accelerator (e.g., 108 of FIG. 1, 200 of FIG. 2). As such, in one or more examples, and as will be discussed further below, a particular GC-ACAM device portion 400 may be configured with an ACAM array 404 for computing the result of a particular predetermined function, and the GC-ACAM device 206 may include any number of such ACAM arrays without departing from the scope of examples disclosed herein. Thus, the description below sets forth a generalized explanation of the operation of the GC-ACAM device portion 400 for executing any predetermined functions that an ACAM array may be configured to execute, including multiplications, exponential functions, logarithmic functions, and the like.

In one or more examples, the GC-ACAM device portion 400 is configured to receive any number of input values (e.g., corresponding to one or more inputs to a predetermined function) and output a binary code (corresponding to an output from the predetermined function).

In one or more examples, the ACAM array 404 includes multiple ACAM cells (discussed further below), which may be arranged in rows and columns. The ACAM cells may search multi-level voltages and store analog ranges. One or more range(s) may be programmed for each ACAM cell of the ACAM array 404. The ACAM array 404 may be programmed with ranges that are used to compute the output of a predetermined function.

During a search operation, one or more analog input values are input to the ACAM array 404 over data lines. One or more ACAM cells in the ACAM array 404 (e.g., a row of ACAM cells, also referred to as an “ACAM row”) then indicates whether the analog input values are matched by their stored range(s). The stored range(s) encoded in an ACAM cell are compared against a respective analog input value. Depending on the implementation of an ACAM cell, a match may occur when an analog input value is inside of the range stored in the ACAM cell or a match may occur when an analog input value is outside of the range stored in the ACAM cell. During a write operation, one or more analog input values are communicated to one or more ACAM cells of the ACAM array 404. The stored range(s) in an ACAM cell are encoded based on a respective analog input value.

The search/write circuit 406 performs a search operation or a write operation for the ACAM array 404. The search/write circuit 406 may obtain values to be written to and/or searched within the ACAM array 404. Thus, in one or more examples, the search/write circuit may include a digital-to-analog converter (DAC), drivers, and the like. In one or more examples, the DAC is used to apply write voltages to ACAM cells of the ACAM array 404 during a write operation, and to apply search voltages to ACAM cells of the ACAM array 404 during a search operation. In other examples, the search/write circuit 406 is configured to obtain analog values (e.g., from the dot product device 204), and apply the analog values as input to the ACAM array 404 without having to perform a conversion. The search/write operations may involve setting appropriate analog voltage levels to represent desired analog input values. For example, the search/write circuit 406 may apply write voltages to program the stored range(s) for ACAM cells of the ACAM array 404, and/or may apply search voltages to test whether the voltages representing input values are matched by the range(s) programmed in ACAM cells of the ACAM array 404. Specifically, the search/write circuit 406 may apply voltages to data lines of the ACAM array 404, such as via appropriate drivers.

An input value may be provided to the GC-ACAM device portion 400 in the digital domain or in the analog domain. In some implementations, the search/write circuit 406 may receive a digital input value, convert the digital input value to an analog input value, and provide the analog input value to the ACAM array 404. Additionally, or alternatively, the search/write circuit 406 may receive an analog input value and provide the analog input value to the ACAM array 404.

In one or more examples, the pre-charge circuit 402 pre-charges a match line for one or more ACAM cells (e.g., an ACAM row) of the ACAM array 404 to a voltage Vₘₗ before a search operation begins. During a search operation, the match line of the ACAM cells remains high (e.g., remains at the voltage Vₘₗ) to indicate a match if the analog input values applied to the ACAM cells are matched by the range(s) stored in the ACAM cells. Alternatively, the match line goes low (e.g., the voltage Vₘₗ drops) as a current in the match line discharges through pull-down transistors of an ACAM cell to indicate a mismatch if the analog input values applied to the ACAM cells are not matched by the range(s) stored in the ACAM cells.

In one or more examples, the sensing circuit 408 senses the outputs of the ACAM cells of the ACAM array 404. The sensing circuit 408 may include a sense amplifier for each ACAM row. The match line of each ACAM row is connected to a sense amplifier. A sense amplifier may be used during a search operation to detect if a match line of an ACAM row is high (indicating a match with one or more analog input values) or low (indicating a mismatch with the analog input values).

In one or more examples, the inverting circuit 410 is connected to the sensing circuit 408. This connection allows the inverting circuit 410 to receive the detected outputs from the sensing circuit 408. The inverting circuit 410 may include an inverter for each sense amplifier. The sense amplifier of each ACAM row is connected to an inverter. As previously alluded to, each match line of the ACAM array 404 may be either high (indicating a match with analog input values) or low (indicating a mismatch with analog input values), and the state of each match line is determined by the sensing circuit 408. The inverting circuit 410 is used to invert the logical states of the match lines (determined by the sensing circuit 408). Thus, if a match line is high (indicating a match) the inverting circuit 410 flips that state to low. Similarly, if a match line is low (indicating a mismatch) the inverting circuit 410 flips that state to high. The purpose of inverting the match lines will be subsequently described.

In one or more examples, the format converter circuit 412 is connected to the inverting circuit 410. This connection may allow the format converter circuit 412 to receive the inverted outputs from the inverting circuit 410. The format converter circuit 212 may include any number (e.g., a series) of exclusive OR (XOR) gates arranged in a cascading configuration to perform a conversion from Gray codes to binary codes. As subsequently described in greater detail, the ACAM array 404 may be programmed such that the inverting circuit 410 outputs a digital value as a Gray code. The format converter circuit 412 converts the Gray code output from the inverting circuit 410 into a binary code. This conversion allows the output of the inverting circuit 410, which is in Gray code format, to be converted into a more universally recognized binary format. This binary output can then be easily processed by other components of the GC-ACAM device 206 (or the computing system 100 more generally).

The GC-ACAM device portion 400 may also include a controller (not separately illustrated) for controlling the components of the GC-ACAM device portion 400. For example, the controller may control the format converter circuit 412, the inverting circuit 410, the sensing circuit 408, the pre-charge circuit 402, and the search/write circuit 406. The controller may include a digital control circuit such as a microcontroller, an application-specific integrated circuit, or the like. The digital control circuit provides necessary control signals and data to the sensing circuit 408 and the search/write circuit 406. For example, the digital control circuit may be used to drive a DAC of the search/write circuit 406, as well as control and coordinate the operation of the DAC. The controller may include other components, such a clock circuit for temporalizing operations in the GC-ACAM device portion 400.

In one or more examples, the components illustrated and described for FIG. 4 make up a programmable computing block of the GC-ACAM device 206. The programmable computing block may be programmed to provide precomputed digital outputs for a predetermined function, such as multiplications, matrix multiplications, exponential functions, logarithmic functions, and the like. The computing block accepts a input (via the search/write circuit 406) from a component, produces an intermediate digital code in Gray format, converts the intermediate digital code to binary format (via the format converter circuit 412), and provides the binary formatted digital code to another component, which may be another programmable computing block.

In some examples, the GC-ACAM device 206 includes a single programmable computing block. In another examples, the GC-ACAM device 206 includes multiple programmable computing blocks. Each programmable computing block may include its own ACAM array and associated peripheral circuits, similar to those described in conjunction with in FIG. 4. These multiple programmable computing blocks can operate in parallel or in series, depending on the computational requirements and the architecture of the system. This modular approach allows for scalability and flexibility in the system design.

The GC-ACAM device portion 400 may be implemented as an integrated circuit (IC) on a semiconductor substrate using suitable microfabrication techniques. Such an IC may integrate the ACAM array 404, the search/write circuit 406, the pre-charge circuit 402, the sensing circuit 408, the inverting circuit 410, the format converter circuit 412, and any other components onto a single chip. The resulting IC may be packaged and integrated into larger systems.

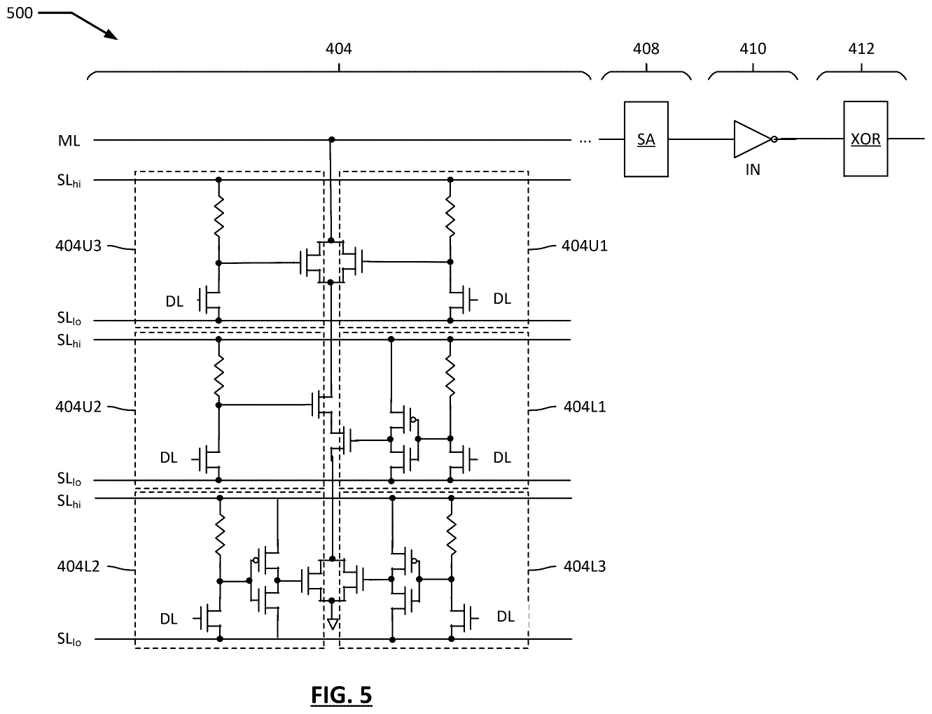

FIG. 5 shows an example of an ACAM cell 500 that may be used to implement the ACAM array 404 shown in FIG. 4 and discussed above. Any number of such ACAM cells may be used in the ACAM array 404. As such, the ACAM array 404 may be configured to execute any number of different predetermined functions, or any particular predetermined function any number of times, as needed to execute the attention mechanism of a transformer. As an example, a portion of the ACAM cells of the ACAM array 404 may be configured to perform multiplication operations, which, when combined with adders (not shown) may perform matrix multiplications. As another example, a portion of the ACAM cells of the ACAM array 404 may be configured to perform multiplication operations to scale the results of a matrix multiplication (e.g., Q*K^{T}) by a scaling factor (e.g., multiplication by one over the square root of dk). As another example, a portion of the ACAM cells of the ACAM array 404 may be configured to perform exponential functions and logarithmic functions for executing the softmax function.

In one or more examples, an ACAM cell may execute predetermined functions by being configured with ranges against with inputs are compared, such that each row of the ACAM cell outputs a bit corresponding to part of a Gray code representing the result of the execution. As an example, two inputs, x and y, may be provided to the ACAM cell 500, and the two inputs are tested against the voltage ranges stored in the ACAM cell to determine whether a match exists. As an example, the output of the ACAM cell may indicate the result of (a≤x<b) V (c≤y<d). In one or more examples, using an appropriate number of such ACAM cells allows a multiplication result of two values to be output as a Gray code. In one or more examples, to perform a matrix multiplication, any number of such multiplications may be performed, and the multiplication results may be added (e.g., by one or more adders) to perform the matrix multiplication.

FIG. 5 shows a part of the GC-ACAM device portion 400. Specifically, FIG. 5 shows a portion of the ACAM array 404, a portion of the sensing circuit 408, a portion of the inverter circuit 410, and a portion of the format converter circuit 412. As shown operating in FIG. 5, an ACAM cell of the ACAM array 404 may store multiple ranges, against which respective analog input values are compared. The output of the inverter IN may be expressed as (a≤x<b) V (c≤y<d), where x is the analog input value on the data line DL of ACAM cell portions 404U1 and 404U2, y is the analog input value on the data line DL of ACAM cell portions 404U2 and 404L2, a is the lower bound stored in the lower bound circuit 402L1 of the ACAM cell, b is the upper bound stored in the upper bound circuit 402U1 of the ACAM cell, c is the lower bound stored in the lower bound circuit 402L2 of the ACAM cell, and d is the upper bound stored in the upper bound circuit 402U2 of the ACAM cell. The upper bound circuit 402U2 and the lower bound circuit 402L2 of the ACAM cell are programmed with maximum upper/lower bounds. The XOR component, as discussed above, is for converting a portion of the result of the function to a Gray code output.

In one or more examples, the ACAM cell shown in FIG. 5 may be configured to compute at least a portion of a result of a one variable function by comparing an input value against ranges stored in the ACAM cell. As an example, the output of the inverter IN may be expressed as (a≤x<b), where x is the analog input value on the data line DL (e.g., of ACAM cell portions 404U2 and 404L1), a is the lower bound stored in the lower bound circuit 402L1 of the ACAM cell, and b is the upper bound stored in the upper bound circuit 402U2 of the ACAM cell. The upper bound circuit 402U1, the upper bound circuit 402U3, the lower bound circuit 402L2, and the lower bound circuit 402L3 of the ACAM cell are programmed with maximum upper/lower bounds. As another example, the boundaries of a range may be stored in two parts (corresponding to their most and least significant bits) and the analog input value is provided in two parts (corresponding to its most and least significant bits). The output of the inverter IN may be expressed as (a≤x<b), where the least significant bits of the analog input value x are provided on the data line DL of ACAM cell portions 404U1 and 404L3, the most significant bits of the analog input value x are provided on the data line DL of the ACAM cell portions 404U3, 404U2, 404L2, and 404L1, the lower bound circuit 402L1 stores the most significant bits of a, the lower bound circuit 402L2 stores the most significant bits of a plus 1, the lower bound circuit 402L3 stores the least significant bits of a, the upper bound circuit 402U3 stores the most significant bits of b, the upper bound circuit 402U2 stores the most significant bits of b plus 1, and the upper bound circuit 402U1 stores the least significant bits of b. In such examples, the output of the ACAM cell, the sense amplifier 404m the inverter 410, and the XOR component 401 may form part of a Gray code of the result of the function being executed.

It should be appreciated that the ACAM cells of the GC-ACAM device 206 may be operated in any of the manners described above, as needed, for performing various operations of the attention equation, using an appropriate number of ACAM cells to perform the required functions. Thus, some ACAM cells may be used to perform multiplication operations that, in conjunction with adders, perform matrix multiplications. Other ACAM cells may be configured to execute one variable functions, such as, for example exponential functions (e.g., ex) and/or logarithmic functions (e.g., log (x)). The ACAM cells may be arranged in array of ACAM cells, with the collective output of such rows forming a Gray coded result of executing a predetermined function. In some examples, the such an output may form part of a larger result. In one or more examples, the output may be used within the attention accelerator 108 as part of a larger calculation (e.g., multiplications and additions for performing matrix multiplication, matrix multiplications and scalar multiplications for softmax function argument, logarithmic and exponential equations for computing the softmax function, and the like). In one or more examples, GC-ACAM portions, such as the GC-ACAM device portion 400 may be configured as groups to perform such computations. Such groups may be configured as part of general computing components of the GC-ACAM device 206. Any number of GC-ACAM devices may be configured as part of the attention accelerator 200, and combined with any number of dot product devices 204 and other circuitry components to form computational cores of the attention accelerator. Such computational cores may be included in the computing system 100 to operate independently, in conjunction with one another, in parallel, and the like to execute the attention mechanism of a transformer.

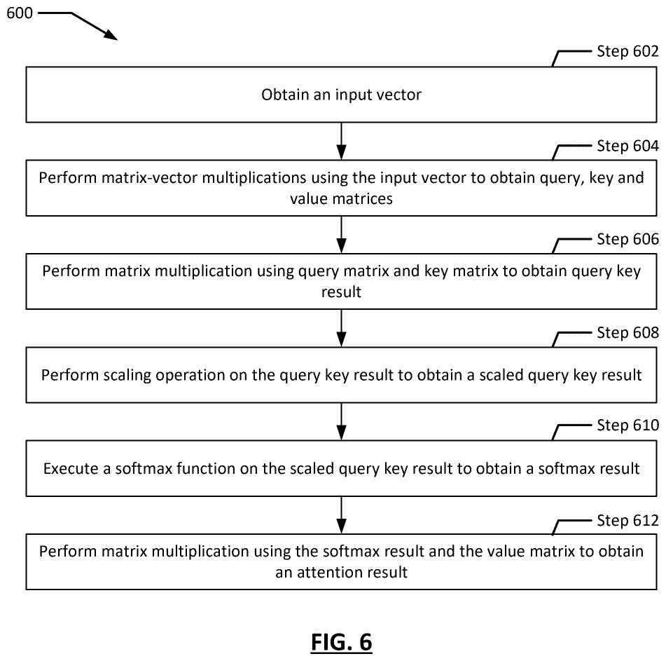

FIG. 6 illustrates an overview of an example method 600 for executing an attention mechanism of a transformer in accordance with one or more examples disclosed herein. In one or more examples, all or any portion of the method 600 may be performed by an attention accelerator (e.g., the attention accelerator 108 of FIG. 1, the attention accelerator 200 of FIG. 2), including any components described and shown therein.

While the various steps in the flowchart shown in FIG. 6 are presented and described sequentially, some or all of the steps may be executed in different orders, some or all of the steps may be combined or omitted, and some or all of the steps may be executed in parallel with other steps of FIG. 6. Accordingly, examples disclosed herein are not limited to the particular set of or order of Steps shown in FIG. 6.

In Step 602, the method 600 includes obtaining an input vector. In one or more examples, the input vector is part of input to a transformer. More specifically, in one or more examples, the input vector forms part of the input to an attention mechanism of a transformer. In one or more examples, the input vector is obtained by an attention accelerator (e.g., the attention accelerator 108 of FIG. 1, the attention accelerator 200 of FIG. 2) of a computing system (e.g., the computing system 100 of FIG. 1). In some examples, the data corresponding to the input vector is obtained from one or more other parts of the computing system (e.g., the processor 102 of FIG. 1, the memory 106 of FIG. 1). Additionally, or alternatively, the data corresponding to the input vector may be obtained from one or more other computing systems (e.g., over a network). In one or more examples, obtaining the input vector includes converting obtained data corresponding to the input vector from a digital form to an analog form (e.g., using the DAC 202 of FIG. 2).

In Step 604, the method 600 includes performing matrix-vector multiplications to obtain a query matrix Q, a key matrix K, and a value matrix V. In one or more examples, a dot product device (e.g., the dot product device 204) of an attention accelerator (e.g., the attention accelerator 108 of FIG. 1, the attention accelerator 200 of FIG. 2) is programmed with weight matrices, such as a query weight matrix W^{Q}, a key weight matrix W^{K}, and a value weight matrix W^{V}. In one or more examples, the input vector obtained in Step 602 is separately multiplied by each of the aforementioned weight matrices, respectively, to obtain the query matrix Q, the key matrix K, and the value matrix V. In one or more examples, the matrix vector multiplications are performed as needed for executing the attention mechanism of a transformer. As such, in one or more examples, all or any portion of the matrix vector multiplications may be performed in parallel prior to the use of the resulting matrices for executing other parts of the attention mechanism. As an example, the Q and K matrices may be calculated in parallel to be provided to other components of the attention accelerator to be used in matrix multiplication. As another example, the V matrix may be separately calculated as need for performing matrix multiplication of V with a result of executing a softmax function.

In Step 606, the method 600 includes performing a matrix multiplication using the query matrix Q and the key matrix K obtained in Step 204 to obtain a query key result. In one or more examples, the query matrix Q is multiplied by the transpose of the key matrix K (e.g., Q*K^{T}). In one or more examples, the matrix multiplication is performed by a GC-ACAM device (e.g., the GC-ACAM device 206 of FIG. 2). In one or more examples, any number of GC-ACAM device portions (e.g., the GC-ACAM device portion 400), including any number of ACAM arrays that include any number of ACAM cells (e.g., the ACAM cell 500 of FIG. 5), along with any number of other circuitry components (e.g., adders) may be used to perform the matrix multiplication. In one or more examples, the matrix multiplication is performed on a row-by-row basis.

In Step 608, the method 600 includes performing a scaling operation using the query key result to obtain a scaled query key result. In one or more examples, the scaling operation is performed by a GC-ACAM device (e.g., the GC-ACAM device 206 of FIG. 2). In one or more examples, the scaling operation includes multiplying the query key result by a scalar value (e.g., one divided by the square root of dk). In one or more examples, the scaling factor is a power of two, the scaling operation may be performed using right-shifter or left-shifter circuitry components.

In Step 610, the method 600 includes executing a softmax function using the scaled query key result obtained in Step 608 to obtain a softmax result. As an example, the softmax function may be executed using a GC-ACAM device (e.g., the GC-ACAM device 206 of FIG. 2). In one or more examples, in order to execute the softmax function using a GC-ACAM device, the softmax function is converted from its conventionally expressed form to a form that does not include division, and instead only includes operations that may be performed using a GC-ACAM device, such as, for example, logarithmic and exponential functions (e.g., performed using ACAM arrays for one variable predetermined function calculations), summations, and subtractions (e.g., using circuitry components, such as adders). As an example, the softmax function may be expressed as:

$$softmax ( Xi ) = exp ( {e}^{Xi} - log ( {\sum }_{j = 1}^{L} {e}^{Xj} ) )$$

Thus, to execute the above function, a number of ACAM arrays may be used to calculate e^{X1} through e^{Xn}. The results of such calculations may be stored, and also provided to adder components so that they may be summed. The result of the summation may be provided to one or more other ACAM arrays to compute the log of the summation, and the aforementioned results may be used to calculate the softmax result based on the above equation.

In Step 612, the method 600 includes performing a matrix multiplication using the softmax result obtained in Step 610 and the value matrix obtained in Step 604 to obtain an attention result. As an example, the softmax result and the value matrix V may be multiplied in a matrix multiplication operation using a GC-ACAM device (e.g., the GC-ACAM device 206 of FIG. 2). In one or more examples, the attention result may be used by a transformer as part of generating an output of the transformer based, at least in part, on the input corresponding to the input vector obtained in Step 602.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. An attention accelerator apparatus, comprising:
a dot product device configured to:
obtain an input vector;
perform a first matrix-vector multiplication operation to obtain a query matrix;
perform a second matrix-vector multiplication operation to obtain a key matrix; and
perform a third matrix-vector multiplication operation to obtain a value matrix; and
a general computing analog content addressable memory (GC-ACAM) device configured to:
perform a first matrix multiplication using the query matrix and the key matrix to obtain a query key result;
perform a scaling operation to obtain a scaled query key result;
execute a softmax function using the scaled query key result to obtain a softmax result; and
perform a second matrix multiplication using the value matrix and the softmax result to obtain an attention result.

2. The attention accelerator apparatus of claim 1, wherein the dot product device comprises:
a first crossbar array programmed with a query weight matrix;
a second crossbar array programmed with a key weight matrix; and
a third crossbar array programmed with a value weight matrix.

3. The attention accelerator apparatus of claim 2, wherein:
the first matrix-vector multiplication operation is performed using the input vector and the query weight matrix;
the second matrix-vector multiplication operation is performed using the input vector and the key weight matrix; and
the third matrix-vector multiplication operation is performed using the input vector and the value weight matrix.

4. The attention accelerator apparatus of claim 1, wherein the input vector corresponds to an input to a transformer.

5. The attention accelerator apparatus of claim 1, wherein the scaling operation comprises a multiplication of the query key result by a scalar value.

6. The attention accelerator apparatus of claim 1, wherein the scaling operation comprises performing at least one left shift operation using the query key result.

7. The attention accelerator apparatus of claim 1, wherein the first matrix multiplication is performed using the query matrix and a transposed representation of the key matrix.

8. The attention accelerator apparatus of claim 1, wherein the softmax function is executed using a softmax function representation that does not include a division operation.

9. The attention accelerator apparatus of claim 1, wherein the GC-ACAM device comprises a plurality of GC-ACAM device portions, each comprising one or more ACAM arrays.

10. A computer-implemented method, comprising:
obtaining, by a dot product device, an input vector;
performing, by the dot product device, a first matrix-vector multiplication operation to obtain a query matrix;
performing, by the dot product device, a second matrix-vector multiplication operation to obtain a key matrix;
performing, by the dot product device, a third matrix-vector multiplication operation to obtain a value matrix;
performing, by a general computing analog content addressable memory (GC-ACAM) device, a first matrix multiplication using the query matrix and the key matrix to obtain a query key result;
performing, by the GC-ACAM device, a scaling operation to obtain a scaled query key result;
executing, by the GC-ACAM device, a softmax function using the scaled query key result to obtain a softmax result; and
performing, by the GC-ACAM device, a second matrix multiplication using the value matrix and the softmax result to obtain an attention result.

11. The computer-implemented method of claim 10, further comprising:
programming, before performing the first matrix-vector multiplication operation, a first crossbar array of the dot product device with a query weight matrix;
programming, before performing the second matrix-vector multiplication operation, a second crossbar array of the dot product device with a key weight matrix; and
programming, before performing the third matrix-vector multiplication operation, a third crossbar array of the dot product device with a value weight matrix.

12. The computer-implemented method of claim 11, wherein:
performing the first matrix-vector multiplication operation comprises using the input vector and the query weight matrix;
performing the second matrix-vector multiplication operation comprises using the input vector and the key weight matrix; and
performing the third matrix-vector multiplication operation comprises using the input vector and the value weight matrix.

13. The computer-implemented method of claim 10, wherein the input vector corresponds to an input to a transformer.

14. The computer-implemented method of claim 10, wherein the scaling operation comprises a multiplication of the query key result by a scalar value.

15. The computer-implemented method of claim 10, wherein the scaling operation comprises performing at least one left shift operation using the query key result.

16. The computer-implemented method of claim 10, wherein the first matrix multiplication is performed using the query matrix and a transposed representation of the key matrix.

17. The computer-implemented method of claim 10, wherein the softmax function is executed using a softmax function representation that does not include a division operation.

18. The computer-implemented method of claim 10, wherein the GC-ACAM device comprises a plurality of GC-ACAM device portions, each comprising one or more ACAM arrays.

19. A non-transitory computer-readable medium storing programming for execution by a computing system, the programming comprising instructions to configure an attention accelerator of the computing system to:
obtain, by a dot product device of the attention accelerator, an input vector;
perform, by the dot product device, a first matrix-vector operation to obtain a query matrix;
perform, by the dot product device, a second matrix-vector operation to obtain a key matrix;
perform, by the dot product device, a third matrix-vector operation to obtain a value matrix;
perform, by a general computing analog content addressable memory (GC-ACAM) device of the attention accelerator, a first matrix multiplication using the query matrix and the key matrix to obtain a query key result;
perform, by the GC-ACAM device, a scaling operation to obtain a scaled query key result;
execute, by the GC-ACAM device, a softmax function using the scaled query key result to obtain a softmax result; and
perform, by the GC-ACAM device, a second matrix multiplication using the value matrix and the softmax result to obtain an attention result.

20. The non-transitory computer-readable medium of claim 19, wherein the softmax function is executed using a softmax function representation that does not include a division operation.
